(19) United States
(12) Patent Application Publication
(10) Pub. No.: US 2013/0074671 A1
(43) Pub. Date: Mar. 28, 2013

(54) CUTTER KNIFE

(71) Applicants: Masahiro TAMAMURA, Osaka-shi (JP); Kenji Okahata, Osaka-shi (JP)

(72) Inventors: Masahiro TAMAMURA, Osaka-shi (JP); Kenji Okahata, Osaka-shi (JP)

(73) Assignee: OLFA CORPORATION, Osaka-shi (JP)

(21) Appl. No.: 13/243,665

(22) Filed: Sep. 23, 2011

(51) Int. Cl. B26D 5/08

(52) U.S. Cl. 83/582

(57) ABSTRACT

A cutter knife includes a cutter body 1 having a sliding contact portion 20 making sliding contact with a cutting object, a cutter member 2 having a cutting blade 22 for cutting the cutting object, a holder member 3 holding the cutter member 2 with the cutting blade 22 being protruded from the cutter body 1, and a biasing member 4 biasing the cutter member 2 to press the cutting blade 22 against the cutting object with a constant pressure when the sliding contact portion 20 of the cutter body 1 is in sliding contact with the cutting object.

### BACKGROUND OF THE INVENTION

1. Field of the Invention

The present invention relates to a cutter knife, and more particularly to a cutter knife suitable for cutting only a topmost one of stacked paper sheets.

2. Description of Related Art

The following cutter knives are conventionally known, for example.

A cutter knife described in Japanese Laid-Open Patent Application No. 2007-50215 allows fine adjustment of the protruding amount of the cutting blade of the cutter member so that just one of stacked paper sheets can be cut.

A cutter knife described in Japanese Laid-Open Patent Application No. 2002-153685 has a cover member covering the cutter member such as to expose only the tip of the cutting blade so that just one of stacked paper sheets can be cut.

A yet another cutter knife described in Japanese Laid-Open Patent Application No. 10-156061 has an elastic pressing piece provided at the distal end of the cutter body for causing the cutting blade to protrude by elastic deformation of this elastic pressing piece, so that the protruding amount of the cutting blade is made constant and just one of stacked paper sheets can be cut.

However, since the above-described cutter knives are all configured such that the cutting blade is protruded by a constant amount, an excessive load applied to the cutting blade during cutting may lead to a failure such as blade chipping or the like. Changes in cutting feel caused by changes in the types of cutting objects or deterioration in sharpness of the cutting blade itself must be dealt with by increasing force that presses the cutting blade against the sheet, which leads to a poor operability.

With the cutter knife described in Japanese Laid-Open Patent Application No. 2007-50215, in particular, the protruding amount of the cutting blade must be finely adjusted in accordance with the difference in sheet thickness, which is practically difficult to achieve successfully because of the difference in sheet thickness being very small. With the cutter knives described in Japanese Laid-Open Patent Application No. 2002-153685 or No. 10-156061, it is necessary to prepare several cutter knives with differing protruding amounts in accordance with the differences in thickness of sheets.

### SUMMARY OF THE INVENTION

An object of the present invention is to provide a cutter knife which allows cutting with an always constant pressing force being applied to the cutting blade thereof.

As means for accomplishing the object,

a cutter knife, comprising:

a cutter body including a sliding contact portion making sliding contact with a cutting object;

a cutter member having a cutting blade for cutting the cutting object; and

a biasing member biasing the cutter member to press the cutting blade against the cutting object with a constant pressure when the sliding contact portion of the cutter body is brought into sliding contact with the cutting object.

With this configuration, the pressing force applied from the cutting blade of the cutter member to a cutting object can be made always constant, irrespective of the difference in pressing force applied from a sliding contact portion of the cutter body to the cutting object. Accordingly, if the cutting object is a plurality of stacked sheet-like articles, only the topmost sheet or only a predetermined number of sheets from the topmost one can be cut in a reliable manner. If the cutting object is thick, incisions can be made to a constant depth in a reliable manner.

The cutter knife, further comprising a pressing force adjusting member adjusting a pressing force applied by the biasing member to press the cutting blade against the cutting object.

With this configuration, a suitable pressing force can be achieved in accordance with the ease of cutting of the cutting object or the difference in sharpness or the like of the cutting blade, so that there will be no loss in operability during cutting.

The cutter member extends from one end to the other end with the cutting blade formed along one side edge thereof, and wherein

the biasing member includes a plate spring arranged along a side edge opposite from the cutting blade of the cutter member.

With this configuration, the configuration can be made compact, simple, and low-cost as it requires only a plate spring disposed along the cutter member.

The plate spring includes a pressing portion pressing the side edge of the cutter member, and wherein

the pressing force adjusting member is provided such as to be slidable along the plate spring attached to the cutter body and includes an abutment portion abutting on the plate spring, so that the pressing force adjusting member is slid along the plate spring to adjust a length between an abutting position where the abutment portion abuts on the plate spring and the pressing portion.

With this configuration, a biasing force by the plate spring can be easily adjusted to increase or decrease the pressing force applied from the cutting blade to the cutting object, only by sliding the pressing force adjusting member to change a position where the abutment portion abuts on the plate spring.

The cutter knife according to any one of claims 1 to 4, further comprising a holder member supporting the cutter member such as to allow the cutter member to rotate when the cutting blade is protruded from the cutter body.

With this configuration, as the cutter member is biased by the biasing member, the cutter member rotates around its rotation support point to press the cutting blade against the cutting object. The pressing force to be applied by the cutting blade can thus be achieved effectively.

The cutter knife according to any one of claims 1 to 5, wherein the holder member can position the cutting blade of the cutter member to at least one of a protruded position and a retracted position.

With this configuration, positioning the cutting blade at a protruding position by moving the cutter member with the holder makes the cutter ready to cut a cutting object, while positioning the cutting blade at a retracted position renders the cutter a safe state in which the cutting blade does not protrude from the cutter body.

According to the present invention, a biasing force of a biasing member is used to press the cutting blade of the cutter member against the cutting object. The pressing force is thus made constant, which can make stable the operability during a cutting operation.

### BRIEF DESCRIPTION OF THE DRAWINGS

FIG. 1 is a partially cut-away perspective view of a cutter knife according to one embodiment;

FIG. 2 is an exploded perspective view of the cutter knife of FIG. 1;

FIG. 3 is a front view of the cutter knife of FIG. 1 in a cutting state;

FIG. 4A is a partially cut-away perspective view of a state of the cutter knife in which a second slider is moved backward to make the elastic deformation length of the plate spring long, and FIG. 4B is a partially cut-away perspective view of a state of the cutter knife in which the second slider is moved forward to make the elastic deformation length of the plate spring short;

FIG. 5A is a front sectional view of a state in which a first slider is moved backward to retract the cutting blade of the cutter member inside the cutter body, and FIG. 5B is a front sectional view of a state in which the first slider is moved forward to protrude the cutting blade of the cutter member out of the cutter body;

FIG. 6 is a schematic sectional view of a cutter knife according to another embodiment;

FIG. 7 is a schematic sectional view of a cutter knife according to another embodiment;

FIG. 8 is a schematic sectional view of a cutter knife according to another embodiment; and

FIG. 9 is a schematic sectional view of a cutter knife according to another embodiment.

### DETAILED DESCRIPTION OF PREFERRED EMBODIMENTS

Embodiments of the present invention will be hereinafter described in accordance with the accompanying drawings. While terms indicating specific directions or positions will be used as required in the following description including, for example, terms such as “upper”, “lower”, “side”, or “end”, these terms are used only for ease of understanding of the invention with reference to the drawings and the technical scope of the present invention is not to be limited by the meaning of these terms. Also the following explanation is given essentially for the purpose of illustration only and is not intended to limit the present invention, products to which it is applied, or purposes thereof.

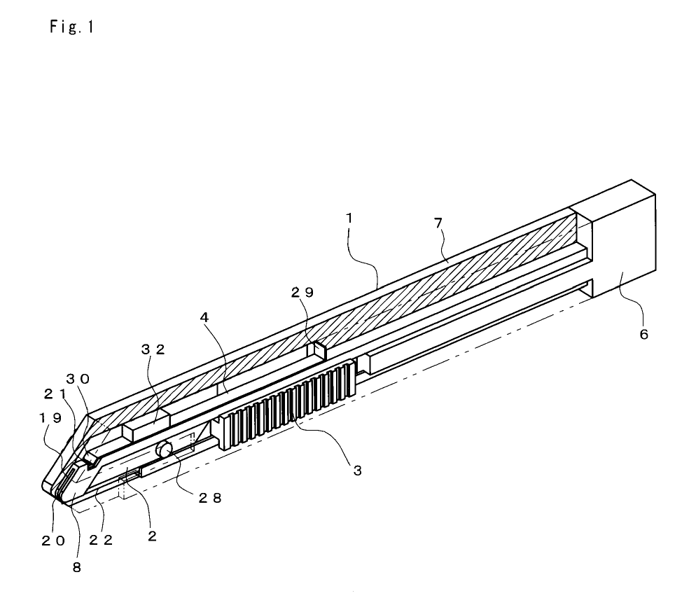

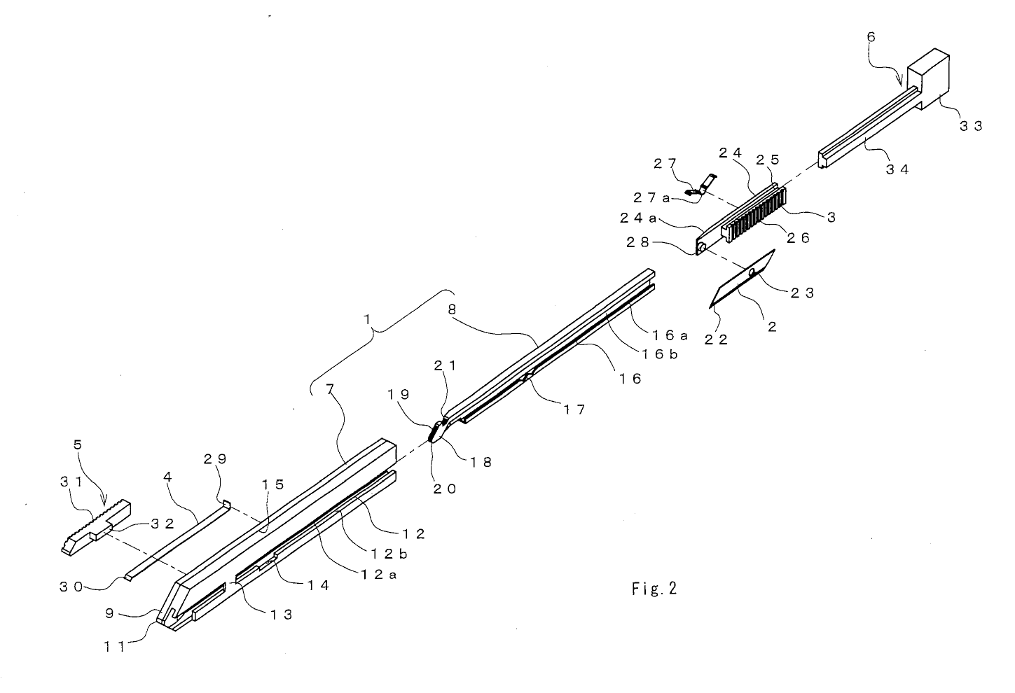

FIG. 1 and FIG. 2 illustrate a cutter knife according to one embodiment. This cutter knife is generally configured to include a cutter member 2, a first slider 3 which is one example of a holder member, a plate spring 4 which is one example of a biasing member, a second slider 5 which is one example of a pressing force adjusting member, and a stopper member 6, all mounted to a cutter body 1.

The cutter body 1 is formed by a first body 7 and a second body 8 mounted inside this first body 7.

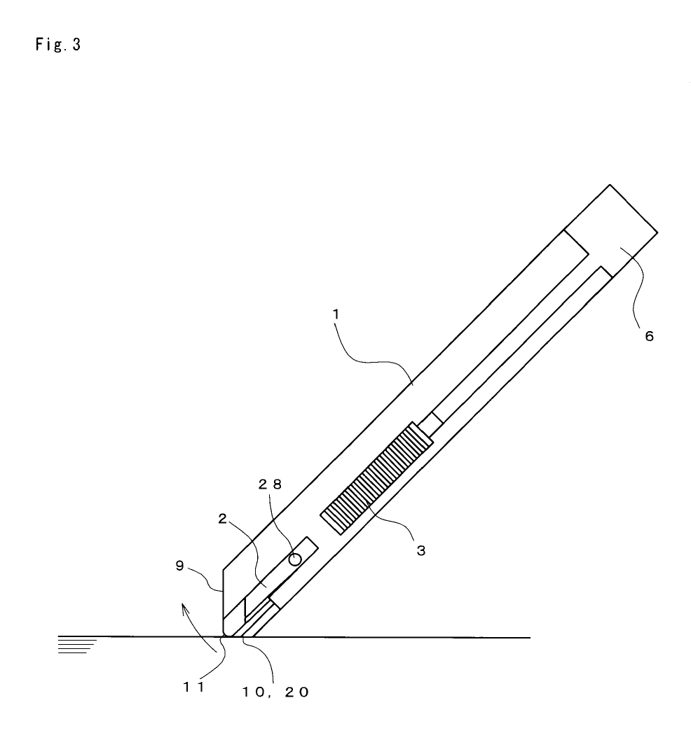

The first body 7 has a long, substantially parallelepiped shape extending from one end to the other end and is obtained by molding synthetic resin. One end face of the first body 7 is formed as a flat surface orthogonal to a lengthwise direction thereof. The other end face of the first body 7 is formed by a first slope 9 and a second slope 10 that are inclined such as to come closer gradually from both sides toward the other end to join at a position offset from the center to one side, as shown in FIG. 3. The point where the both slopes meet is formed as a circular arc surface 11.

The first body 7 is formed with a first guide groove 12 that connects both end faces as shown in FIG. 2. The first guide groove 12 is formed by a wide portion 12a and a narrow portion 12b, the narrow portion 12b being open to one lateral face of the first body 7. The narrow portion 12b is coupled to the first body 7 by a coupling portion 13 at a position a predetermined distance from the other end. A release recess 14 is formed in one of the inner faces of the narrow portion 12b. An opening 15 is formed in the remaining other lateral face of the first body 7 such as to communicate with the first guide groove 12. This opening 15 forms a passage for accommodating a plate spring 4 inside a communication hole, as well as a mounting receptacle for slidably mounting the second slider 5.

The second body 8 is a long metal press-formed article extending from one end to the other end and pressed into the first guide groove 12 of the first body 7 from one end thereof. The second body 8 is formed with a second guide groove 16 in which a slider body 24 of the first slider 3 to be described later is slidably supported. The second guide groove 16 is formed by a wide portion 16a and a narrow portion 16b similarly to the first guide groove 12 of the first body 7, the narrow portion 16b being open in the same direction. A pair of locking recesses 17 is formed substantially in the shape of the letter W in one of the inner faces forming the narrow portion 16b. These locking recesses 17 are used to position the first slider 3 respectively at a withdrawn position where the cutter member 2 is positioned at a retracted position and an advanced position where the cutter member is positioned at a protruded position. The other end of the second body 8 is formed by a guide portion 18 where a distal end portion of the cutter member 2 is disposed. The guide portion 18 is formed with a slit 19 in which the cutter member 2 can be fitted, and a sliding contact portion 20 at a distal end portion thereof, which will be coplanar with a distal end portion (mainly the second slope 10) of the first body 7. A notch 21 is formed in an upper part of the guide portion 18, with the cutter member 2 being fitted inside the slit 19 such that an edge portion opposite from the cutting blade 22 can be pushed therein. The sliding contact portion 20 is thus formed not only by the guide portion 18 but also by the distal end portion of the first body 7, so that it has a larger contact area with the cutting object to reduce the pressure applied to the cutting object. Namely, if the guide portion 18 only is protruded, the cutting object may be damaged depending on the force applied, but such a risk can be avoided by this structure. It is, however, also possible to adopt a design in which only the guide portion 18 is protruded.

The cutter member 2 is in the form of a thin plate and one side edge thereof forms the cutting blade 22. The distal end of the cutter member is formed such that the cutting blade 22 side protrudes gradually toward the tip. A circular mounting hole 23 is formed at the rear end of the cutter member 2.

The first slider 3 is made up of the slider body 24 and a first operating portion 26 integrated with this slider body 24 via a rib 25. The slider body 24 is plate-like, and formed with an inclined surface 24a on an outer lateral face at one end, which is inclined such that the thickness is reduced gradually toward the distal end. A middle portion on the outer lateral face can receive an elastic locking piece 27 attached thereto. The elastic locking piece 27 is a plate spring bent such as to form a circular arc protrusion 27a in the middle. The first slider 3 can be positioned relative to the second body 8 by engaging and disengaging this protrusion 27a with and from the respective locking recesses 17 formed in the second body 8. The slider body 24 on the other hand is formed with a columnar boss 28 on an inner lateral face thereof. This boss 28 is arranged in the mounting hole 23 of the cutter member 2 so as to pivotally support the cutter member 2. The first operating portion 26 is formed only over the rear side and not the front side of the slider body 24. The first operating portion 26 is formed on its surface with multiple grooves regularly spaced in the lengthwise direction to provide slippage prevention when operating it with a finger thereby to enhance operability. The first operating portion 26, the slider body 24, and the rib 25 together form grooves on both sides. The slider body 24 is slidably set inside the cutter body 1 such as to be held between both inner faces of the second body 8 that form the narrow portion 16b of the second guide groove 16.

The plate spring 4 is a long slip of plate and inserted from the opening 15 formed in the first body 7. At one end of the plate spring 4 is a locking portion 29 formed by bending the end upwards at right angles. The locking portion 29 is locked in a locking groove (not shown) formed inside the opening 15 of the first body 7 to prevent displacement of the plate spring 4 in the lengthwise direction. The other end of the plate spring 4, on the other hand, is formed as a pressing portion 30 by bending the plate diagonally downward. The pressing portion 30 presses a side edge of the cutter member 2 positioned inside the slit 19 through the notch 21 formed in the guide portion 18 of the second body 8.

The second slider 5 is a block-like member mounted into the opening 15 formed in the first body 7, and formed by a second operating portion 31 and an abutment portion 32. The second operating portion 31 has a similar configuration as that of the first operating portion 26 of the first slider 3 and is mounted in the opening 15. The abutment portion 32 is set inside the first body 7 through the opening 15 so as to abut on an upper face of the plate spring 4 disposed therein. Sliding the second operating portion 31 with a finger to move the position of the abutment portion 32 relative to the opening 15 displaces the position where the abutment portion 32 abuts on the plate spring 4, whereby a biasing force of the plate spring 4 can be adjusted according to the Hooke's law. Namely, sliding the second slider 5 toward one end makes the deformable range of the plate spring 4 long so that the pressing force by the cutting blade 22 of the cutter member 2 is reduced. Conversely, sliding the second slider toward the other end makes the deformable range of the plate spring 4 shorter, so that the pressing force by the cutting blade 22 of the cutter member 2 is increased. Here, the second slider 5 is set in a position such that the cutting blade 22 of the cutter member 2 applies a pressing force that allows only a topmost one of stacked paper sheets as the cutting object to be cut.

The stopper member 6 is formed by a stopper body 33 and an insert 34 having a squarely protruded cross section integral with the stopper body. The stopper body 33 is attached to one end of the cutter body 1 by inserting the insert 34 into the second guide groove 16.

Next, how the cutter knife having the above-described configuration is assembled will be explained.

The second body 8 is pressed into the first guide groove 12 of the first body 7 to join them together, thereby obtaining the cutter body 1. The boss 28 of the first slider 3 is positioned inside the mounting hole 23 of the cutter member 2 to pivotally support the cutter member 2 relative to the first slider 3. The elastic locking piece 27 is mounted to the first slider 3.

The first slider 3 and cutter member 2 are inserted into the second guide groove 16 of the second body 8, and the first operating portion 26 is operated to move the first slider 3 toward the distal end of the cutter body 1. Here, the protrusion 27a of the elastic locking piece 27 is locked in the locking recess 17 on one end side to position the cutter member 2.

Successively, the plate spring 4 is inserted through the opening 15 of the first body 7, and its locking portion 29 is positioned so that the plate spring 4 is set in a position where its pressing portion 30 can press an edge of the cutter member 2. The second slider 5 is mounted to the opening 15 so as to abut the abutment portion 32 on the plate spring 4 inserted therein.

Lastly, the stopper member 6 is mounted to one end of the cutter body 1. This makes the first slider 3 slidable only within the range in which the cutter member 2 can be positioned at the retracted position and the protruded position, respectively. The stopper member 6 is removable, so that the stopper member 6 can be removed to allow the first slider 3 and cutter member 2 to slide to the rear end of the cutter body 1 to replace the cutter member 2 if the cutting blade 22 of the cutter member 2 has lost its sharpness.

Next, the operation of the cutter knife having the above-described configuration will be explained. The cutter knife is mainly used for cutting only a topmost one of paper sheets that are the cutting object when they are stacked.

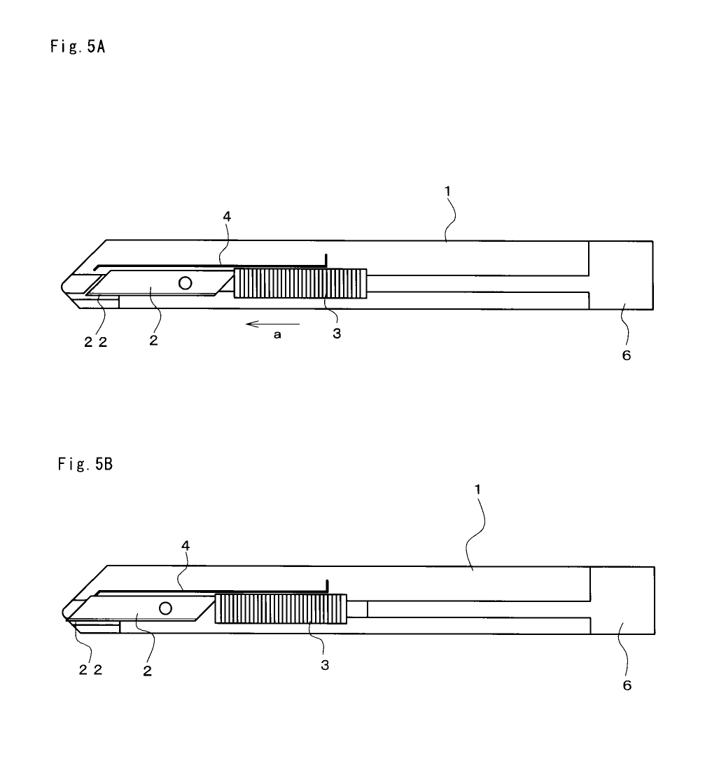

Before cutting the sheet, as shown in FIG. 5A, the first slider 3 is positioned at the withdrawn position, so that the cutter member 2 is positioned at a waiting position. The plate spring 4 abuts on the upper face of the second body 8, its pressing portion 30 being positioned in the notch 21 of the second body 8. However, since the cutter member 2 is positioned at the waiting position, the side edge of the cutter member 2 is not positioned in the notch 21. Therefore, the cutting blade 22 at the tip of the cutter member 2 does not protrude from the sliding contact portion 20 of the cutter body 1.

For cutting the sheet, the first slider 3 is moved in the direction of the arrow a from the state shown in FIG. 5A to the advanced position shown in FIG. 5B. Thereby the cutter member 2 is positioned at the protruded position. The side edge of the cutter member 2 is now positioned in the notch 21 of the second body 8, where the side edge is pressed by the pressing portion 30 of the plate spring 4. Thereby, the cutting blade 22 at the tip of the cutter member 2 protrudes from the sliding contact portion 20 of the cutter body 1.

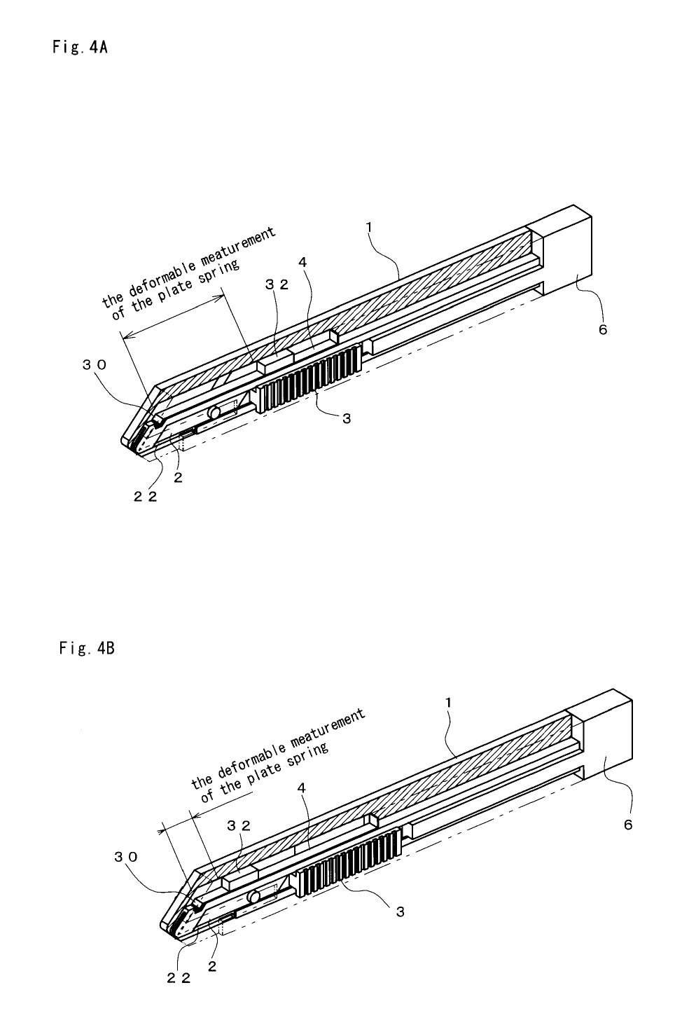

Then the second slider 5 is slid to displace the position of the abutment portion 32, thereby adjusting the biasing force by the plate spring 4 according to the Hooke's law as mentioned above so that the cutting blade 22 of the cutter member 2 applies a predetermined pressing force. When the distance from the abutment portion 32 to the pressing portion 30 is long so that the plate spring 4 has a long elastic deformation length as shown in FIG. 4A, the pressing force applied to the cutter member 2 is small. Accordingly the pressing force applied from the cutting blade 22 to the cutting object is small. On the other hand, when the distance from the abutment portion 32 to the pressing portion 30 is short so that the plate spring 4 has a short elastic deformation length as shown in FIG. 4B, the pressing force applied to the cutter member 2 is large. Accordingly the pressing force applied from the cutting blade 22 to the cutting object is large. This pressing force may be set to a suitable value that allows the cutter member 2 to cut just one sheet. Assuming that the cutting blade 22 of the cutter member 2 has a constant sharpness in an initial state, respective positions of the abutment portion 32 where an appropriate pressing force can be achieved in accordance with the types of the cutting objects (such as copier paper, newspaper, magazines or the like) may be indicated as a scale on a side edge of the opening 15 for the positioning of the second slider 5. Thereby, the user only needs to slide the second slider 5 along the scale in accordance with the type of the cutting object so as to set the cutter to a mode in which only a topmost sheet can be cut. In other words, no trial cutting is necessary. When the cutting blade 22 has lost its sharpness, or when something hard to cut is selected as the cutting object, the second slider 5 is slid to a suitable position on the distal end side so as to increase the pressing force applied by the cutting blade 22 of the cutter member 2.

After adjusting the pressing force to be applied by the cutting blade 22 of the cutter member 2, the sliding contact portion 20 of the cutter body 1 is brought into sliding contact with the topmost one of stacked sheets, as shown in FIG. 3. The cutter member 2 is rotatably supported on the boss 28 of the first slider 3, and the cutting blade 22 is pressed against the topmost sheet with a constant pressing force of the plate spring 4 having a biasing force adjusted by the abutment portion 32 of the second slider 5. This pressing force is set suitably so that only the topmost sheet can be cut with the cutting blade 22. Therefore, cutting of the sheet by the cutting blade 22 of the cutter member 2 is carried out always with a constant pressing force even if the sliding contact portion 20 of the cutter body 1 is pressed against the sheet. Accordingly, only one topmost sheet can be cut reliably.

As described above, with the cutter knife according to this embodiment, the pressing force applied from the cutting blade 22 of the cutter member 2 to the cutting object can be made constant, based on the force applied at the sliding contact portion 20 making sliding contact with the cutting object. Thus it is possible to cut only one topmost sheet reliably, irrespective of the operability of the cutter knife. Even if an excessive load is exerted to the cutting blade 22, it is retracted by elastic deformation of the plate spring 4, and will not be damaged.

The present invention is not limited to the configuration described in the above embodiment, and various modifications are possible.

For example, while the pressing force to be applied by the cutting blade 22 of the cutter member 2 is achieved by the plate spring 4 disposed along the cutter member 2 in the above-described embodiment, the following configurations would also be possible:

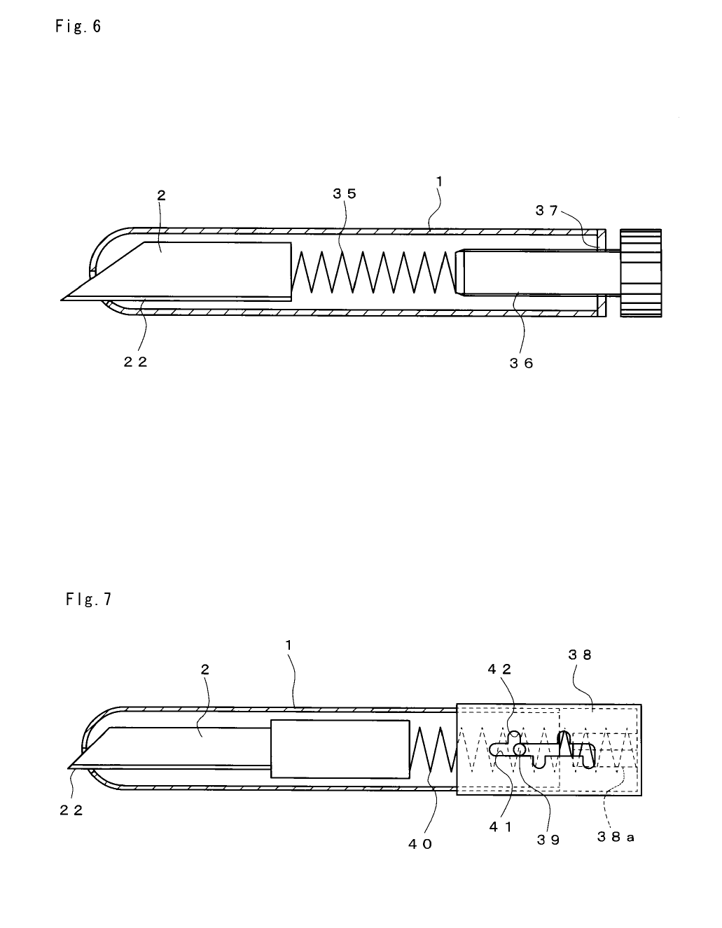

Namely, in FIG. 6, the cutter member 2 is disposed such as to be movable in the lengthwise direction relative to the cutter body 1. One end of a spring 35 is connected to the rear end of the cutter member 2. A screw member 36 which is a movable member is connected to the other end of the spring 35. The screw member 36 is screw-coupled to a female threaded portion 37 provided to the cutter body 1. The screw member 36 can be moved in the lengthwise direction relative to the cutter body 1 by changing the position where the screw member 36 is screw-coupled to the female threaded portion 37 so as to adjust a biasing force of the spring 35 applied to the cutter member 2. Various articles such as a coil spring, urethane can be employed for the spring 35, as long as it can apply a biasing force to the cutter member 2 in a protruding direction.

With the cutter knife shown in FIG. 6, the circular arc surface at the distal end of the cutter body 1 (where the cutting blade protrudes) is brought into sliding contact with a cutting object to cut it. The pressing force of the cutting blade 22 of the cutter member 2 applied to the cutting object is determined in accordance with the biasing force of the spring 35. Accordingly, similarly to the above-described embodiment, the cutting object can be cut with a constant pressing force. When the cutter knife is not in use, the portion where the cutting blade 22 protrudes may be covered with a cap or the like, or, the cutting blade 22 may be retracted into the cutter body 1 by turning the screw member 36.

The stopper member 38 shown in FIG. 7 may be employed for the above-noted movable member instead of the screw member. Namely, a boss 39 is formed on an outer circumferential surface of the cutter body 1. The stopper member 38 is formed in a tubular shape with a bottom and slidably mounted to one end of the cutter body 1. The stopper member 38 includes a coil spring 40 held on a shaft 38a provided inside thereof, so that the cutter member 2 can be biased in the protruding direction with this coil spring 40. The stopper member 38 is also formed with a guide groove 41 along which the boss of the cutter body 1 can move in the lengthwise direction. The guide groove 41 is provided with locking grooves 42 at several locations in a continuous manner. At the locking grooves 42, the boss 39 can engage with or disengage from by turning the stopper member 38 relative to the cutter body 1. Changing the locking grooves 42 with which the boss 39 engages adjusts a biasing force applied by the coil spring 40 to the cutter member 2.

With the cutter knife shown in FIG. 7, the stopper member 38 may be pushed in and turned in accordance with the type of the cutting object so as to change the position of the locking groove 42 with which the boss 39 engages.

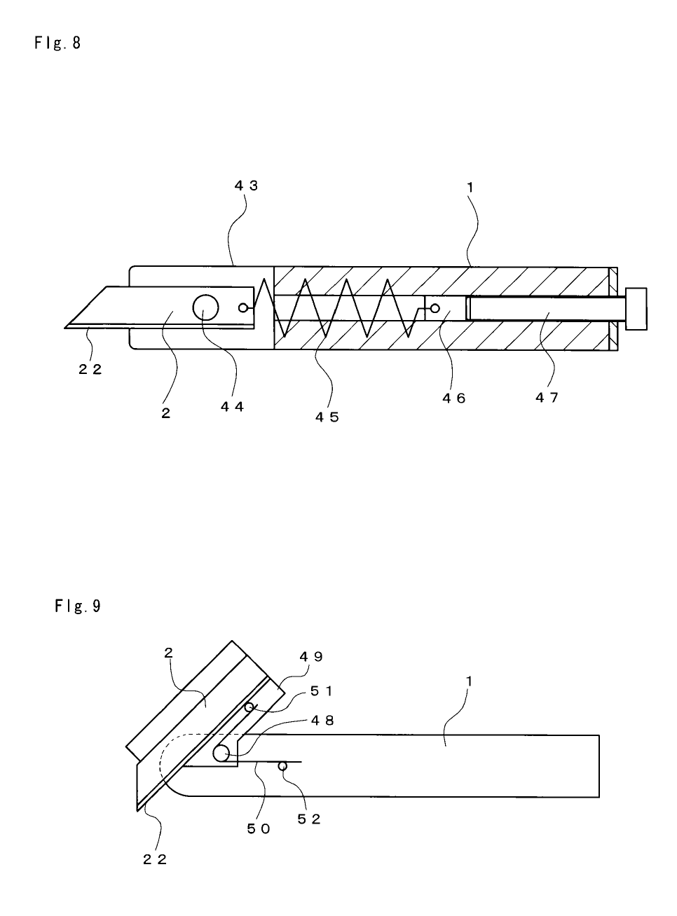

In FIG. 8, an arm 43 is formed at the distal end of the cutter body 1 extending a predetermined distance, and the cutter member 2 is attached to this arm 43 such as to be rotatable around a support shaft 44. One end of a coil spring 45 is connected to the cutter member 2 near the support shaft 44. The other end of the coil spring 45 is connected to a movable member 46 provided inside the cutter body 1 to be slidable along the lengthwise direction thereof. Displacing the position of this movable member 46 by turning a screw member 47 can adjust the tension force of the coil spring 45 applied to the cutter member 2.

With the cutter knife shown in FIG. 8, in an inclined state, a circular arc surface at one corner at the distal end of the arm 43 is brought into sliding contact with a cutting object. Thereby the cutting blade 22 at the tip of the cutter member 2 is pressed against the cutting object. This pressing force is determined by the tension force of the coil spring 45 applied to the cutter member 2. Therefore, by turning the screw member 47 to adjust the pressing force so that a desired value is achieved, it is possible to cut just one sheet.

In FIG. 9, a circular arc surface is formed at the distal end of the cutter body 1, and a cutter holder 49 holding the cutter member 2 is attached close thereto such as to be rotatable around a support shaft 48. A winding portion of a spring 50 is mounted to the support shaft 48. One end extending from the winding portion of the spring 50 makes pressure contact with a boss 51 provided on the cutter holder 49, while the other end makes pressure contact with a boss 52 provided on the cutter body 1. Thereby, the cutting blade 22 at the tip of the cutter member 2 can be pressed against a cutting object.

With the cutter knife shown in FIG. 9, bringing the circular arc surface at the distal end of the cutter body 1 into sliding contact with the cutting object will allow the cutting blade 22 at the tip of the cutter member 2 to be pressed against the cutting object by the biasing force of the spring 50 to cut the same. In this case, the biasing force of the spring 50 can be adjusted by adjusting the inclination angle of the cutter body 1 relative to the cutting object. Namely, to increase the pressing force to be applied by the cutting blade 22, the inclination angle of the cutter body is adjusted to be larger relative to the cutting object.

While the cutter member 2 used in the above-described embodiment is a solid single blade, it may have a configuration that is separable at predetermined intervals as with common cutter knives. In this case, the first slider 3 needs to be able to position the cutter member 2 not only the two, which are protruded and retracted positions, but a plurality of positions that allow the cutter member 2 to advance stepwise as the cutter member is separated off.

While only one of the sheets that are the cutting object is cut in the above-described embodiment, various other situations can be dealt with such as making incisions to a constant depth to the cutting object, or cutting not only one sheet but several sheets at the same time, by adjusting the biasing force to set the pressing force to be applied by the cutting blade 22 of the cutter member 2.

While the biasing force applied to the cutter member 2 is adjusted by moving the second slider 5 to change the position where the plate spring 4 is pressed in the above-described embodiment, this adjustment of biasing force may be achieved by sliding the plate spring 4 itself. More specifically, the plate spring 4 may be slid so as to displace the position where it contacts the cutter body 1. Thereby, the elastic deformation length of the plate spring 4, i.e., the biasing force applied to the cutter member 2, is adjusted when cutting the cutting object with the cutting blade 22 of the cutter member 2.

While the first body 7 and second body 8 are formed as separate parts in the above-described embodiment, they can be integrally formed, for example, by molding synthetic resin.

While the cutter member 2 is configured to be either rotated or reciprocated in the lengthwise direction thereof in the above-described embodiments, it can be configured to move parallel to a direction orthogonal to the lengthwise direction. In short, the cutter member 2 may be moved in any direction as long as it is moved relative to the cutter body 1.

1. A cutter knife, comprising:
a cutter body including a sliding contact portion making sliding contact with a cutting object;
a cutter member having a cutting blade for cutting the cutting object; and
a biasing member biasing the cutter member to press the cutting blade against the cutting object with a constant pressure when the sliding contact portion of the cutter body is brought into sliding contact with the cutting object.

2. The cutter knife according to claim 1, further comprising a pressing force adjusting member adjusting a pressing force applied by the biasing member to press the cutting blade against the cutting object.

3. The cutter knife according to claim 2, wherein the cutter member extends from one end to the other end with the cutting blade formed along one side edge thereof, and wherein the biasing member includes a plate spring arranged along a side edge opposite from the cutting blade of the cutter member.

4. The cutter knife according to claim 3, wherein the plate spring includes a pressing portion pressing the side edge of the cutter member, and wherein the pressing force adjusting member is provided such as to be slidable along the plate spring attached to the cutter body and includes an abutment portion abutting on the plate spring, so that the pressing force adjusting member is slid along the plate spring to adjust a length between an abutting position where the abutment portion abuts on the plate spring and the pressing portion.

5. The cutter knife according to claim 1, further comprising a holder member supporting the cutter member such as to allow the cutter member to rotate when the cutting blade is protruded from the cutter body.

6. The cutter knife according to claim 5, wherein the holder member can position the cutting blade of the cutter member to at least one of a protruded position and a retracted position.
